(19) United States
(12) Patent Application Publication
(10) Pub. No.: US 2009/0144455 A1
(43) Pub. Date: Jun. 4, 2009

(54) FIRMWARE UPDATING SYSTEM FOR UPDATING FIRMWARE OF A DISPLAY DEVICE AND METHOD THEREOF

(76) Inventor: Feng-Lin Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/324,882

(22) Filed: Nov. 27, 2008

(30) Foreign Application Priority Data
Nov. 29, 2007 (TW) 096145364

(51) Int. Cl. G06F 3/00

(52) U.S. Cl. 710/8

(57) ABSTRACT

A firmware updating system includes a computer apparatus including a video output interface and a control unit electrically connected to the video output interface for controlling the video output interface to output data corresponding to a new firmware. The firmware updating system further includes a display device having a video input interface for electrically connecting with the video output interface so as to receive the data corresponding to the new firmware transmitted from the video output interface. The display device further includes a first memory and a micro control unit electrically connected to the video output interface and the first memory for processing the data corresponding to the new firmware received by the video input interface and storing the new firmware in the first memory.

### BACKGROUND OF THE INVENTION

1. Field of the Invention

The present invention relates to a firmware updating system for updating firmware of a display device and method thereof, and more particularly, to a firmware updating system for updating firmware of a display device and method thereof by using a video transmission interface.

2. Description of the Prior Art

The firmware of the display apparatus is used to control the display device to adjust the brightness, contrast, color, focus, and gamma correction of the display apparatus. During the development of the display apparatus, the manufacturer of the display apparatus tests continuously the firmware of the display apparatus so as to obtain the most stable version of the firmware. Even after the display apparatus leaves the factory, the manufacturer may publish new firmware to add a new function or improve the compatibility between the computer system and the display apparatus according to the requirements of the users. Thus, the latest firmware can optimize the display apparatus.

The display device is requested to update the new firmware when the display device operates abnormally or the display device adds new function. Refer to FIG. 1. FIG. 1 is a functional diagram of a firmware updating system 10 in the prior art. The firmware updating system 10 includes a computer apparatus 12, an adapter 14, a first display device 16, and a second display device 18. The computer apparatus 12 includes a first port 20 and a second port 22, and the first display device 16 includes a micro control unit (MCU) 24. The first display device 16 further includes a memory 26 electrically connected to the MCU 24. The memory 26 can be a flash ROM. The first display device 16 further includes a signal interface 28. The new firmware of the first display device 16 is stored in the computer apparatus 12, and the old firmware of the first display device 16 is stored in the memory 26. The signal interface 28 of the first display 16 is electrically connected to the adapter 14 when updating the old firmware of the first display 16. Then the adapter 14 is connected to the first port 20 of the computer apparatus 12. The new firmware data stored in the computer apparatus 12 can be transmitted to the MCU 24 of the first display 16 via connection of the first port 20, the adapter 14, and the signal interface 28. The old firmware in the memory 26 is updated to be the new firmware after the MCU 24 receives the new firmware data. The first port 20 can be a parallel port, COM port, USB port of the computer apparatus 12, and so on. The signal interface 28 of the first display device 16 can be a D-sub, and so on. The first display device 16 can not be operated when the computer apparatus 12 is updating the first display device 16 so that an updating result can not be obtained via the display of the first display device 16. There is a need to use the second port 22 for connecting with the second display device 18 to monitor the firmware updating procedure of the first display device 16 by the computer apparatus 12.

In addition, the adapter conforming to special specification is utilized for transmission interface of updating the display device. If the user does not have the adapter, the new firmware can not be updated. The display device needs to be delivered back to the manufacturer for updating the firmware. Furthermore, the signal is interfered easily because of using the adapter, and the adapter is damaged easily. Additionally, when the firmware of the display device is updated, the computer apparatus needs to connect with another display device, so as to monitor the updating state of the firmware. However, if there is a situation of data transmitting failure or power failure during firmware updating procedure, the display device can not operate normally anymore or the new firmware can not be updated again. The casing of the display device must be taken apart for replacing the memory. There is a need to find a solution to simplify firmware update of a display device.

### SUMMARY OF THE INVENTION

The present invention provides a firmware updating system for updating firmware of a display device and method thereof by using a video transmission interface.

A firmware updating system for updating firmware of a display device, the firmware updating system includes a computer apparatus. The computer apparatus includes a video output interface, and a control unit. The control unit electrically connected to the video output interface for controlling the video output interface to output data corresponding to a new firmware. A display device includes a video input interface, a first memory, a micro control unit. The video input interface electrically connected to the video output interface of the computer apparatus for receiving the data corresponding to the new firmware transmitted from the video output interface. The micro control unit electrically connected to the video input interface and the first memory for processing the data corresponding to the new firmware received by the video input interface so as to store the new firmware in the first memory.

A method for updating firmware of a display device includes: connecting a computer apparatus with a display device electrically, transmitting a new firmware from a video output interface of the computer apparatus to a video input interface of the display device, and replacing an old firmware stored in a first memory of the display device with the new firmware by a micro control unit of the computer apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram of a firmware updating system in the prior art.

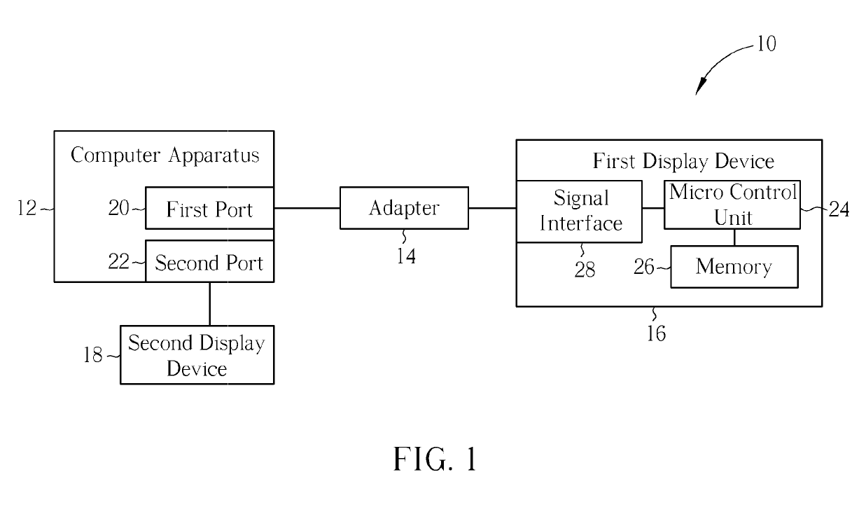

FIG. 2 is a functional diagram of a firmware updating system of the present invention.

FIG. 3 is a flow chart of the firmware updating system for updating firmware of a display device of the present invention.

### DETAILED DESCRIPTION

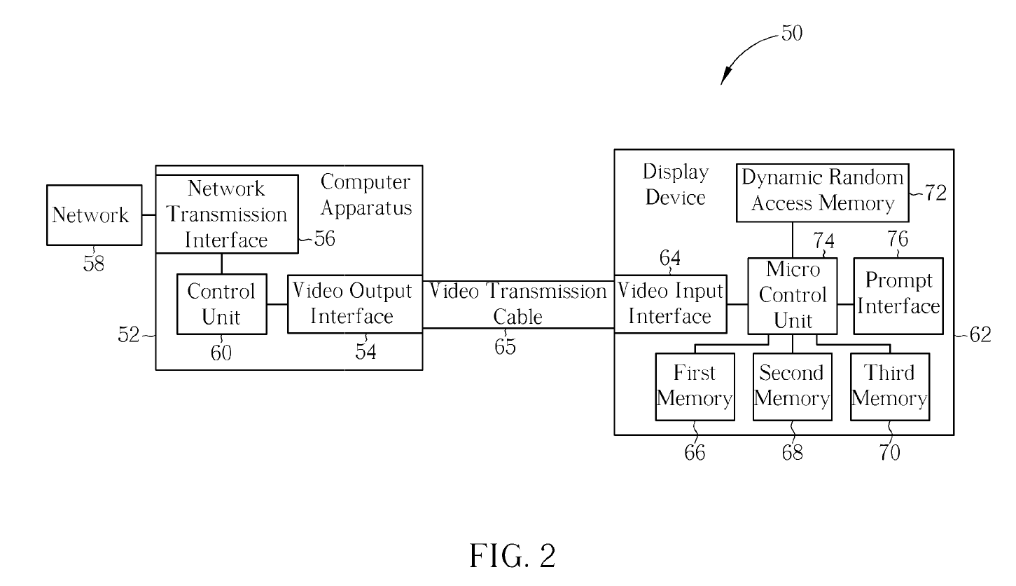

Refer to FIG. 2. FIG. 2 is a functional diagram of a firmware updating system 50 of the present invention. The firmware updating system 50 includes a computer apparatus 52. The computer apparatus 52 includes a video output interface 54, which can be a D-sub port, a digital visual interface (DVI) port, a high-definition multimedia interface (HDMI), and so on. The computer apparatus 52 further includes a network transmission interface 56 for receiving a new firmware from a network 58. The computer apparatus 52 further includes a control unit 60 electrically connected to the video output interface 54 and the network transmission interface 56 for controlling the video output interface 54 to output data corresponding to the new firmware. The firmware updating system 50 also includes a display device 62, which further includes a video input interface 64, a first memory 66, a second memory 68, a third memory 70, a dynamic random access memory (DRAM) 72, a micro control unit 74, and a prompt interface 76. The video input interface 64 is electrically connected to the video output interface 54 of the computer apparatus 52 through a video transmission cable 65 for receiving data corresponding to the new firmware transmitted from the video output interface 54. The video input interface 64 can be an analog video port, a digital video interface port, or a high definition multimedia interface. The transmission between the video input interface 64 and the video output interface 54 could also be achieved by wireless transmission. The first memory 66 can be a flash ROM for storing firmware data of the display device 62. The second memory 68 stores specification information of the display device 62, such as model or serial number of the display device 62. The second memory 68 can be an electrically erasable programmable read-only memory (EEPROM). The third memory 70 backs up old firmware of the display device 62, in which the third memory 70 can be a read only memory (ROM). The dynamic random access memory 72 (DRAM) is used to temporarily back up data corresponding to the new firmware received from the video input interface 64. The micro control unit (MCU) 74 is electrically connected to the video input interface 64, the first memory 66, the second memory 68, the third memory 70, and the dynamic random access memory 72. The MCU 74 processes the data corresponding to the new firmware from the video input interface 64 and stores the new firmware in the first memory 66. The prompt interface 76 is electrically connected to the MCU 74 for prompting users as to whether the MCU 74 successfully stores the new firmware in the first memory 66. The prompt interface 76 can be an on screen display (OSD) interface or a speaker, thereby using visual screens or sound to prompt users whether the MCU 74 successfully stores the new firmware in the first memory 66.

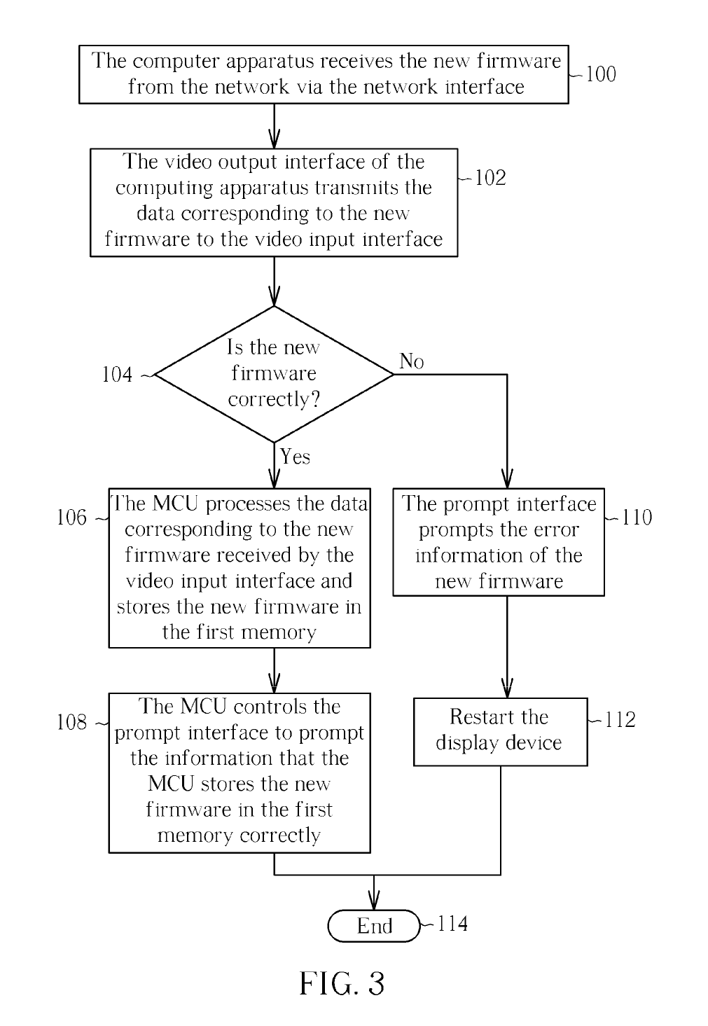

Refer to FIG. 3. FIG. 3 is a flow chart illustrating the firmware updating system 50 updating firmware of a display device 62 of the present invention. The method of the present invention preferably includes the following steps:

Step 100: the computer apparatus 52 receives the new firmware via the network interface 56 from the network 58.

Step 102: the video output interface 54 of the computer apparatus 52 transmits data corresponding to the new firmware to the video input interface 64 of the display 62.

Step 104: the MCU 74 verifies whether the new firmware is accurate. If the new firmware is accurate, execute step 106; if the new firmware is inaccurate, execute step 110.

Step 106: the MCU 74 processes the data corresponding to the new firmware received by the video input interface 64, and stores the new firmware in the first memory 66.

Step 108: the MCU 74 controls the prompt interface 76 to prompt users information regarding whether the MCU 74 successfully stores the new firmware in the first memory 66.

Step 110: the prompt interface 76 prompts the error message regarding the new firmware to the user.

Step 112: restart the display device 62.

Step 114: end.

The computer apparatus 52 could first connect to internet and receive the new firmware from network 58 via network transmission interface 56. For example, the computer apparatus 52 could be connected to the service website of the display device 62 to check whether new the firmware for the display device 62 is available. If a new firmware is available for the display device 62, it can be downloaded directly from the service website and users can select the new firmware corresponding to the serial number of the display device 62 in service website. Or the computer apparatus 52 can be connected with the video input interface 64 of the display device 62 via the video output interface 54. For example, the specification information of the display device 62 can be received from the second memory 68 of the display device 62 via a display data channel bus (DDC Bus), such as a model or serial number of the display device 62 as a basis for downing the new firmware from service website.

Afterwards, users can operate the computer apparatus 52 to transmit a control instruction to the display device 62 via data bus of the video transmission cable 65 for updating firmware. A service program can be stored in the display device 62 for monitoring whether the computer apparatus 52 transmits the control instruction to the display device 62. The display device 62 is switched to an updating mode, does not display general images at this time and displays an information window of the prompt interface 76 instead to notify users of updating firmware. Then the video output interface 54 of the computer apparatus 52 transmits data corresponding to the new firmware to the video input interface 64 of the display device 62 via the video transmission cable 65. For example, if the video output interface 54 and the video input interface 64 are an analog video port respectively, the video output interface 54 outputs the data corresponding to the new firmware to the video input interface 64 via a display data bus. If the video output interface 54 and the video input interface 64 are a digital video interface port respectively, the video output interface 54 outputs the data corresponding to the new firmware to the video input interface 64 via a transition minimized differential signaling (TMDS) channel. That is, the data packet corresponding to the new firmware is transferred to the packet conforming to TMDS. If the video output interface 54 and the video input interface 64 are a high definition multimedia interface respectively, the video output interface 54 outputs the data corresponding to the new firmware to the video input interface 64 via the display data bus. The data that the video input interface 64 receives is bucked up in the dynamic random access memory 72 which is also used for temporarily storing image data of the display device 62. Because the display device 62 only displays OSD images instead of general images in the updating mode, the dynamic random access memory 72 can be used for temporarily storing the data corresponding to the new firmware. If the display device 62 does not have the dynamic random access memory 72, the new firmware is stored in the first memory 66 from the MCU 74 directly. After that, the MCU 74 reads the data corresponding to the new firmware stored in the dynamic random access memory 72, restores the data corresponding to the new firmware to the new firmware, and verifies accuracy of the new firmware by confirming the date of the firmware edition, the serial number, and the checksum.

If the MCU 74 verifies the new firmware is accurate, the new firmware can be stored in the first memory 66 so as to accomplish the upgrade of the firmware for the display device 62. After that, the MCU 74 controls the prompt interface 76 to prompt users that the new firmware is successfully stored in the first memory 66. If the prompt interface 76 is an on screen display (OSD) interface, the MCU 74 controls the prompt interface 76 to display a message for prompting users that the display device 62 is updated successfully. If the prompt interface 76 is a speaker, the MCU 74 controls the prompt interface 76 to make a sound for prompting users that the display device 62 is updated successfully.

On the other hand, if the MCU 74 verifies the new firmware is inaccurate, the new firmware can not be stored in the first memory 66 so as to avoid the wrong firmware being executed in the display device 62. After that, the MCU 74 controls the prompt interface 76 to prompt users that the new firmware is not stored in the first memory 66. If the prompt interface 76 is the OSD interface or a speaker, the MCU 74 controls the prompt interface 76 to display the message or to make the sound for prompting users that the display 62 is updated unsuccessfully. Then the MCU 74 restarts the display device 62 for waiting next firmware update.

Additionally, the third memory 70 is used for backing up the old firmware of the display device 62 or for storing the standard firmware which keeps base operation of the display 62, such as operations of updating the firmware and OSD. The MCU 74 keeps base operation and operates firmware update of the display device 62 by reading the standard firmware stored in the third memory 70.

In contrast to the prior art, the firmware updating system and the method thereof of the present invention can update the firmware of the display device via the video transmission interface, such as D-sub, DVI, or HDMI interface, and without using the adapter or special transmission cables. The computer apparatus reads the specification information of the display device from internet or the display device and makes sure whether the service website of the display device provides new firmware to update. The new firmware is transmitted completely to the display device, and the accuracy is verified by the MCU. Afterward, the new firmware is written in the flash ROM to reduce risk of the firmware updating. Furthermore, the display device interacts with users via OSD display when updating the firmware. Users can handle the procedure of the firmware updating and the operation result by monitoring the firmware updating via the OSD display of the display device without using additional monitors. It can avoid situation of data transmission failure or power failure in firmware updating procedure by bucking up the standard firmware or the old firmware. The present invention provides a firmware updating system for updating firmware of a display device that users can update by themselves.

Those skilled in the art will readily observe that numerous modifications and alterations of the device and method may be made while retaining the teachings of the invention.

What is claimed is:

1. A firmware updating system for updating firmware of a display device, the firmware updating system comprising:
a computer apparatus comprising:
a video output interface; and
a control unit electrically connected to the video output interface for controlling the video output interface to output data corresponding to a new firmware; and
a display device comprising:
a video input interface electrically connected to the video output interface of the computer apparatus for receiving the data corresponding to the new firmware transmitted from the video output interface;
a first memory; and
a micro control unit electrically connected to the video input interface and the first memory for processing the data corresponding to the new firmware received by the video input interface so as to store the new firmware in the first memory.

2. The firmware updating system of claim 1, wherein each of the video output interface and the video input interface is a D-sub port.

3. The firmware updating system of claim 2, wherein the data corresponding to the new firmware is output from the video output interface through a display data channel bus (DDC Bus) to the video input interface.

4. The firmware updating system of claim 1, wherein each of the video output interface and the video input interface is a digital visual interface port.

5. The firmware updating system of claim 4, wherein the data corresponding to the new firmware is output from the video output interface through a transition minimized differential signaling (TMDS) channel to the video input interface.

6. The firmware updating system of claim 1, wherein each of the video output interface and the video input interface is a high-definition multimedia interface.

7. The firmware updating system of claim 6, wherein the data corresponding to the new firmware is output from the video output interface through a display data channel bus (DDC Bus) to the video input interface.

8. The firmware updating system of claim 1, wherein the firmware updating system further comprises a video transmission cable connected between the video output interface and the video input interface.

9. The firmware updating system of claim 1, wherein the computer apparatus further comprises a network transmission interface for receiving the new firmware via a network.

10. The firmware updating system of claim 1, wherein the display device further comprises a second memory electrically connected to the micro control unit for storing a specification information of the display device.

11. The firmware updating system of claim 1, wherein the display device further comprises a third memory electrically connected to the micro control unit for backing up an old firmware.

12. The firmware updating system of claim 1, wherein the display device further comprises a dynamic random access memory (DRAM) electrically connected to the micro control unit for temporarily storing the data corresponding to the new firmware received from the video input interface.

13. The firmware updating system of claim 1, wherein the display device further comprises a prompt interface electrically connected to the micro control unit for prompting whether the micro control unit successfully stores the new firmware in the first memory.

14. A method for updating firmware of a display device, comprising:
connecting a computer apparatus with a display device electrically;
transmitting a new firmware from a video output interface of the computer apparatus to a video input interface of the display device; and
replacing an old firmware stored in a first memory of the display device with the new firmware by a micro control unit of the computer apparatus.

15. The method of claim 14, further comprising receiving the new firmware by the computer apparatus via a network.

16. The method of claim 14, further comprising verifying whether the new firmware is correct by the micro control unit.

17. The method of claim 14, further comprising prompting whether the micro control unit stores the new firmware in the first memory correctly by a prompt interface of the display device.

18. The firmware updating system of claim 17, wherein the prompt interface displays whether the micro control unit successfully stores the new firmware in the first memory via a screen.

19. The firmware updating system of claim 17, wherein the prompt interface sounds whether the micro control unit stores the new firmware in the first memory correctly via a speaker.
